(19) United States
(12) Patent Application Publication
(10) Pub. No.: US 2015/0008189 A1
(43) Pub. Date: Jan. 8, 2015

(54) EVAPORATIVE TREATMENT METHOD FOR AQUEOUS SOLUTION

(71) Applicant: SASAKURA ENGINEERING CO., LTD., Osaka (JP)

(72) Inventors: Junji MIZUTANI, Osaka (JP); Yo FUJIMOTO, Osaka (JP); Tatsuya TAGUCHI, Osaka (JP)

(21) Appl. No.: 14/325,141

(22) Filed: Jul. 7, 2014

(30) Foreign Application Priority Data
Jul. 8, 2013 (JP) 2013-142346

(51) Int. Cl. B01D 1/22; C02F 1/04

(52) U.S. Cl. CPC B01D 1/22; C02F 1/048; C02F 2101/10
USPC 210/714

(57) ABSTRACT

The present invention provides an aqueous solution evaporative treatment method that makes it possible to efficiently perform evaporative treatment of a silica-containing aqueous solution. The aqueous solution evaporative treatment method comprises a seed crystal mixing step of adding to and mixing with a silica-containing aqueous solution a silicate as seed crystals and an evaporative concentration step of evaporatively concentrating the aqueous solution together with the seed crystals. The silicate is preferably magnesium silicate and/or calcium silicate.

### BACKGROUND OF THE INVENTION

### Cross-Reference to Related Applications

This application claims priority to Japanese Application No. 2013-142346, filed on Jul. 8, 2013, which is incorporated by reference in its entirety.

1. Field of the Invention

The present invention relates to an evaporative treatment method for an aqueous solution, and more specifically, relates to an aqueous solution evaporative treatment method in which a silica-containing aqueous solution is evaporated by indirect heating.

2. Description of the Related Art

When evaporating an aqueous solution containing impurities such as silica by indirect heating, scale builds up on the heat transfer surface of a heat exchanger, and the heat transfer coefficient is likely to deteriorate. Accordingly, to date, measures to address this phenomenon have been investigated. For example, Patent JP-A 2006-305541 discloses a waste water treatment method in which sodium carbonate is added to waste water containing calcium and sulfate to precipitate the calcium contained in the waste water as crystals of calcium carbonate, and then the waste water is concentrated through boiling/evaporation by indirect heating.

### SUMMARY OF THE INVENTION

Although the aforementioned waste water treatment method is effective when the impurity contained in waste water is calcium, there is still a concern that scale buildup on the heat transfer surface becomes problematic in the case of an aqueous solution containing a large amount of silica. As a conventional silica removal method, a so-called hot-lime process is known in which magnesium oxide or magnesium carbonate is added to an aqueous silica solution, and then silica is precipitated by increasing the temperature to about 90° C. to reduce the silica concentration. However, with the hot-lime process, not only is the consumption of chemicals, heating energy, and the like for precipitation of silica increased, but also separate treatment of the generated precipitate sludge is required, thus resulting in an increase of treatment cost.

Therefore, embodiments disclosed herein provide an aqueous solution evaporative treatment method that makes it possible to efficiently perform evaporative treatment of a silica-containing aqueous solution.

Embodiments disclosed herein may achieve this by an evaporative treatment method for an aqueous solution, comprising a seed crystal mixing step of adding to and mixing with a silica-containing aqueous solution a silicate as seed crystals, and an evaporative concentration step of evaporatively concentrating the aqueous solution together with the seed crystals.

It is preferable that in this evaporative treatment method for an aqueous solution, the silicate is magnesium silicate and/or calcium silicate.

Moreover, it is preferable that in the seed crystal mixing step, the aqueous solution before adding the seed crystals comprises silica in a concentration of 50 ppm or higher, and magnesium and calcium each in a concentration of 10 ppm or lower.

Moreover, it is preferable that the seed crystals contained in a concentrated liquid produced in the evaporative concentration step are used in the next seed crystal mixing step.

Aqueous solution evaporative treatment methods disclosed herein make it possible to efficiently perform evaporative treatment of a silica-containing aqueous solution.

### BRIEF DESCRIPTION OF THE DRAWINGS

FIG. 1 is a schematic configurational diagram of an evaporative treatment apparatus used for an aqueous solution evaporative treatment method according to one embodiment of the present invention.

### DETAILED DESCRIPTION OF THE INVENTION

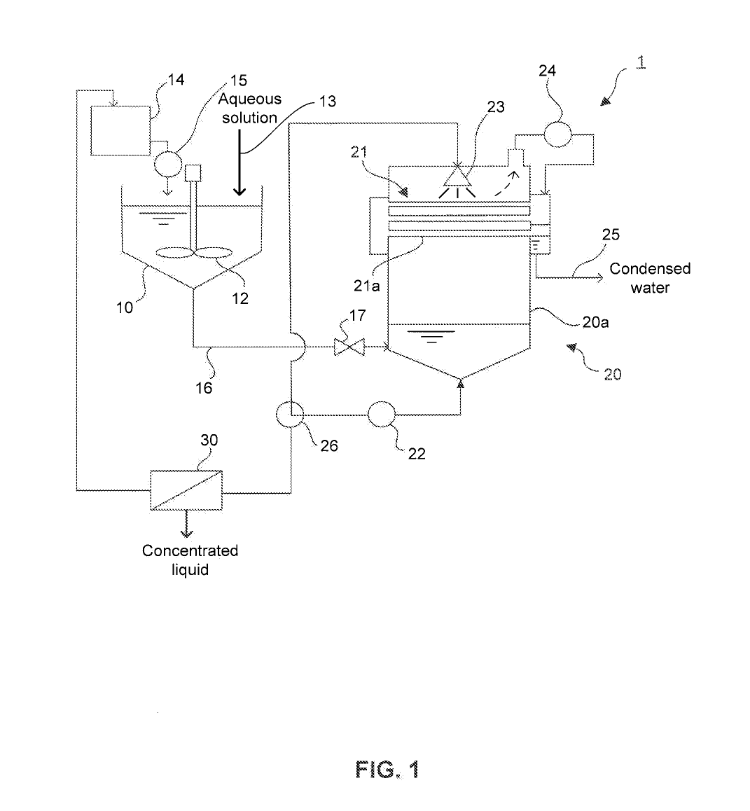

Below, one embodiment of the present invention will now be described with reference to the attached drawings. FIG. 1 is a schematic configurational diagram of an evaporative treatment apparatus used for an aqueous solution evaporative treatment method according to one embodiment of the present invention. As shown in FIG. 1, an evaporative treatment apparatus 1 includes a reservoir tank 10 in which an aqueous solution to be treated is stored and an evaporative concentration device 20 to which the aqueous solution is supplied from the reservoir tank 10.

The reservoir tank 10 includes a stirrer 12, and an aqueous solution supplied from an aqueous solution supply line 13 and seed crystals supplied from a seed crystal tank 14 by the operation of an injection pump 15 are uniformly mixed inside the reservoir tank 10.

The evaporative concentration device 20 is a falling film type in which the fluid evaporates on the outer surface of a tube, and includes a heat exchanger 21 that has heat exchanger tubes 21a horizontally positioned in an evaporator 20a and a spraying nozzle 23 that sprays an aqueous solution onto the surface of the heat exchanger tubes 21a. Steam produced in the evaporator 20a is compressed by a compressor 24 to have high temperature and high pressure, introduced into the heat exchanger tubes 21a to be used for heating the aqueous solution, and then discharged as condensed water from a condensed liquid discharge tube 25. The aqueous solution stored in the bottom of the evaporator 20a is repeatedly sprayed from the spraying nozzle 23 by the operation of a circulating pump 22. The concentrated liquid concentrated in the evaporator 20a is introduced into a solid-liquid separator 30 by the operation of a switching valve 26, and seed crystals are thus separated and discharged to the outside. The separated seed crystals are returned to the seed crystal tank 14 and reused. The solid-liquid separator 30 can be, for example, a centrifugation type, a filter type, or a sedimentation type, or may be a combination of such types.

The configuration of the evaporative concentration device 20 is not particularly limited, and, for example, the heat exchanger tubes 21a may be a vertical type instead of a horizontal type. Moreover, for the heating medium that travels inside the heat exchanger tubes 21a, a separate heating medium may be introduced from outside instead of using a heating medium obtained by mechanical vapor recompression as in this embodiment. Also, the evaporative concentration device 20 can be configured to be a multiple-stage type by arranging the evaporator 20a as a multi-effect evaporator as necessary.

Next, a method for performing evaporative treatment of an aqueous solution using the above-described evaporative treatment apparatus 1 will now be described.

Examples of the aqueous solution supplied from the aqueous solution supply line 13 to the reservoir tank 10 include, in addition to waste liquids generated in factories and similar facilities, contaminated water generated during mining of natural gas such as coal seam gas and shale gas, underground hot water used for geothermal power generation, and the like. It is preferable that silica is contained in the aqueous solution to such an extent that buildup of silica scale becomes problematic due to evaporative concentration in the evaporative concentration apparatus 20, and, for example, the method is effective when the silica concentration in the aqueous solution is 50 ppm or higher. This is because, in evaporative concentration, the aqueous solution is usually concentrated about 4 to 10 fold, and, therefore, even when the silica concentration is 50 ppm, the concentration reaches 200 to 500 ppm in the evaporative concentration device 20, possibly posing silica scale problems.

Seed crystals accommodated in the seed crystal tank 14 are crystals of a silica-containing low-solubility silicate ((xM₂O.ySiO₂) that is a component of the aqueous solution, and, for example, seed crystals may be crystals of one or more of magnesium silicate, calcium silicate, calcium magnesium silicate, aluminum silicate, calcium aluminum silicate, and the like. In particular, magnesium silicate (MgO)n.(SiO₂)m) and calcium silicate ((CaO)n.(SiO₂)m) seed crystals are, as will be demonstrated in the working examples described below, suitably usable in applications for treating aqueous solutions generated during mining of coal seam gas, shale gas, and the like. Seed crystals in a particle form are usable as-is, or those in a slurry form in which crystals are dispersed in water or the like are usable as well.

In the reservoir tank 10, silicate seed crystals are added to an aqueous solution and uniformly stirred, and thus the silicate seed crystals, serving as nuclei, allow silica contained in the aqueous solution to undergo crystal growth. The amount of seed crystals supplied from the seed crystal tank 14 to the reservoir tank 10 is preferably an amount sufficient for promoting seed crystal growth without impairing the flowability of the aqueous solution. In the reservoir tank 10, the pH may be adjusted by suitably adding a pH adjuster.

When large amounts of further scale components such as magnesium and calcium other than silica are contained in the aqueous solution, it is preferable to suitably select seed crystals so as to allow these components together with silica to grow into seed crystals. That is to say, when the scale components contained in large amounts in the aqueous solution are silica and magnesium, it is preferable to select magnesium silicate as seed crystals, and when the scale components contained in large amounts in the aqueous solution are silica and calcium, it is preferable to select calcium silicate as seed crystals. Concerning the scale components such calcium and magnesium other than silica contained in the aqueous solution, it is possible to perform ion exchange treatment using, for example, a weakly acidic cation exchange resin, desalting treatment using a reverse osmosis membrane (RO membrane), or the like before adding seed crystals in order to reduce these scale components to such an extent that generation of scale does not become problematic.

Through various tests, the inventors have confirmed that crystals of simple silica grow on silicate seed crystals such as magnesium silicate and calcium silicate. That is to say, even when magnesium, calcium, and the like are scarcely present in the aqueous solution (for example, 10 ppm or lower), addition of silicate seed crystals to the aqueous solution makes it possible to effectively prevent generation of silica scale on the evaporative concentration apparatus 20.

Thereafter, opening the supply valve 17 allows the aqueous solution to be supplied from the reservoir tank 10 to the evaporative concentration device 20, and evaporative concentration of the seed crystal-containing aqueous solution is performed. In the aqueous solution to be supplied to the evaporative concentration device 20, silica, which is a scale component, undergoes crystal growth in the reservoir tank 10, with seed crystals serving as nuclei. Therefore, even when the concentration of scale components is increased due to the evaporative concentration of the aqueous solution in the evaporative concentration device 20 and exceeds the scale production threshold, due to the precipitation of scale components with the existing seed crystals serving as nuclei, generation of new nuclei is suppressed, and it is thus possible to prevent scale buildup on the heat exchanger 21.

A concentrated liquid concentrated in the evaporative concentration device 20 is introduced into the solid-liquid separator 30 due to the operation of the switching valve 26. In the solid-liquid separator 30, seed crystals with a large particle size that have undergone crystal growth are separated by centrifugation or precipitation in a settling tank and, after impurity removal by washing or the like, are supplied to the seed crystal tank 14. Therefore, even in the case where large amounts of seed crystals are supplied to the reservoir tank 10, most of the seed crystals are recovered and can be used for the next seed crystal growth in the reservoir tank 10, and it is thus possible to achieve high economical efficiency.

Although it is also possible to continuously supply the aqueous solution from the reservoir tank 10 to the evaporative concentration device 20 while the evaporative concentration device 20 is in operation, it is preferable to supply the aqueous solution in a batch-wise manner in which the aqueous solution is supplied after the concentrated liquid produced in the evaporative concentration device 20 is completely discharged to the outside. Moreover, it is preferable that after seed crystals are added to the reservoir tank 10, the aqueous solution is stirred and left to stand still until seed crystal growth in the reservoir tank 10 terminates, and then supplied to the evaporative concentration device 20 to initiate evaporative concentration. It is thereby possible to promote crystal growth on seed crystals in the evaporative concentration device 20, and to more reliably prevent scale buildup on the heat exchanger 21 and the like.

As a working example, an evaporative treatment apparatus 1 having the same configuration as FIG. 1 was used to perform treatment on an aqueous solution composed of simulated liquid coal seam gas having the components shown in Table 1 below. As seed crystals, magnesium silicate ((MgO).3(SiO₂)) was used in an amount of 2 kg/m³. Seed crystals were added to the aqueous solution in a reservoir tank 10 and constantly stirred to thus form a uniform slurry, and the slurry was supplied to an evaporative concentration device 20 to perform evaporative concentration. In the evaporative concentration device 20, 126 heat exchanger tubes 21a each having an outer diameter of 19 mm and a length of 460 mm were used. In the evaporative concentration device 20, the evaporation temperature was 72° C., the evaporation amount was 10 kg/h, the concentration rate was 11 fold, and the duration of operation was 28 days. Then, there was no scale buildup on the heat exchanger tubes 21a, and deterioration of heat transfer coefficient was not observed.

| Na | Ca | Mg | Cl | K | HCO₃ | CO₃ | SiO₂ |
|---|---|---|---|---|---|---|---|
| 18,000 | 5 | 5 | 12,000 | 110 | 6,000 × 10³ | 1,900 | 220 |

As another working example, evaporative concentration was performed on an aqueous solution under the same conditions as in the above-described working example except that calcium silicate ((CaO)x.(SiO))x) was used as seed crystals in an amount of 2 kg/m³. Then, even 28 days after the beginning of operation, there was no scale buildup on the heat exchanger tubes 21a, and deterioration of heat transfer coefficient was not observed.

On the other hand, as a comparative example, evaporative concentration was performed on an aqueous solution under the same conditions as in the working examples except that calcium carbonate (CaCO₃) was used as seed crystals in an amount of 2 kg/m³. Then, scale buildup on the heat exchanger tubes 21a was observed 14 days after the beginning of operation, and the heat transfer coefficient decreased to 80% of the value obtained immediately after the beginning of operation. It was not possible to remove the built-up scale by acid cleaning alone, and alkali cleaning was necessary, thus suggesting the possibility of silica scale.

Moreover, as other comparative examples, concerning the ease where calcium sulfate (CaSO₄) was used as seed crystals in an amount of 2 kg/m³ and the case where silicon dioxide (SiO₂) was used as seed crystals in an amount of 2 kg/m³, evaporative concentration was performed on an aqueous solution under the same conditions as in the working examples. In both cases, scale buildup on the heat exchanger tubes 21a was observed 14 days after the beginning of operation, and the heat transfer coefficient decreased to 80% of the value obtained immediately after the beginning of operation.

1 Evaporative treatment apparatus

10 Storage tank

14 Seed crystal tank

20 Evaporative concentration device

21 Heat exchanger

21a Heat exchanger tube

30 Solid-liquid separator

1. An evaporative treatment method for an aqueous solution, comprising:
a seed crystal mixing step of adding to and mixing with a silica-containing aqueous solution a silicate as seed crystals, and
an evaporative concentration step of evaporatively concentrating the aqueous solution together with the seed crystals.

2. The evaporative treatment method for an aqueous solution according to claim 1, wherein the silicate is magnesium silicate and/or calcium silicate.

3. The evaporative treatment method for an aqueous solution according to claim 1, wherein in the seed crystal mixing step, the aqueous solution before adding the seed crystals comprises silica in a concentration of 50 ppm or higher and magnesium and calcium each in a concentration of 10 ppm or lower.

4. The evaporative treatment method for an aqueous solution according to claim 1, wherein the seed crystals contained in a concentrated liquid produced in the evaporative concentration step are used in the next seed crystal mixing step.
